(19) United States
(12) Patent Application Publication
(10) Pub. No.: US 2025/0298725 A1
(43) Pub. Date: Sep. 25, 2025

(54) INFORMATION PROCESSING METHOD, INFORMATION PROCESSING APPARATUS AND INFORMATION PROCESSING DEVICE

(71) Applicant: Lenovo (Beijing) Limited, Beijing (CN)

(72) Inventor: Guiqing LI, Beijing (CN)

(21) Appl. No.: 19/078,369

(22) Filed: Mar. 13, 2025

(30) Foreign Application Priority Data
Mar. 22, 2024 (CN) 202410338351.7

(51) Int. Cl. G06F 11/362; G06F 9/4401; G06F 11/34

(52) U.S. Cl. CPC G06F 11/366; G06F 9/4411; G06F 11/3476

(57) ABSTRACT

Embodiments of the disclosure provide an information processing method, which includes: when an exception occurs in an operating system, calling a crash dump driver to read a first memory capacity occupied by a storage resource allocated for a dump memory block; based on the first memory capacity, obtaining a determination result as to whether the storage resource of the dump memory block satisfies a storage resource required when a dump miniport driver corresponding to a storage device is initialized; and based on the determination result, determining a target memory capacity of the dump memory block, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

### CROSS-REFERENCE TO RELATED APPLICATION

This application claims priority to Chinese Patent Application No. 202410338351.7, filed on Mar. 22, 2024, the content of which is incorporated herein by reference in its entirety.

### TECHNICAL FIELD

The present disclosure generally relates to the field of computer technology, and in particular to an information processing method, an information processing apparatus, and an information processing device.

### BACKGROUND

For an operating system, if an abnormal instruction executed by the central processing unit causes the system to crash, in order to accurately analyze the specific cause of the operating system crash afterward, the operating system crash dump component and the storage device dump miniport component may be used to dump the memory information (such as operating status and data information, etc.) to a storage device when the operating system crashes so that the memory information can be read after the operating system is restarted. However, in some cases, especially when using special hardware or there are compatibility issues with the driver(s), the miniport may fail to load, thereby affecting the storage of the crash dump file and causing storage failure.

### SUMMARY

In view of the foregoing, embodiments of the disclosure provide an information processing method, an information processing apparatus, and an information processing device. The technical solution of the embodiments of the disclosure is implemented as follows.

In one aspect, embodiments of the disclosure provide an information processing method, and the method includes: when an exception occurs in an operating system, calling a crash dump driver to read a first memory capacity occupied by a storage resource allocated for a dump memory block; based on the first memory capacity, obtaining a determination result as to whether the storage resource of the dump memory block satisfies a storage resource required when a dump miniport driver corresponding to a storage device is initialized; and based on the determination result, determining a target memory capacity of the dump memory block, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

In another aspect, embodiments of the disclosure provide an information processing device, including a memory and one or more processors, where the memory stores a computer program executable by the one or more processors, and when executing the computer program, the one or more processor are configured to perform: when an exception occurs in an operating system, calling a crash dump driver to read a first memory capacity occupied by a storage resource allocated for a dump memory block; based on the first memory capacity, obtaining a determination result as to whether the storage resource of the dump memory block satisfies a storage resource required when a dump miniport driver corresponding to a storage device is initialized; and based on the determination result, determining a target memory capacity of the dump memory block, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

In another aspect, embodiments of the disclosure provide a non-transitory computer-readable storage medium, storing a computer program that, when being executed, causes at least one processor to implement an information processing method, and the method includes: when an exception occurs in an operating system, calling a crash dump driver to read a first memory capacity occupied by a storage resource allocated for a dump memory block; based on the first memory capacity, obtaining a determination result as to whether the storage resource of the dump memory block satisfies a storage resource required when a dump miniport driver corresponding to a storage device is initialized; and based on the determination result, determining a target memory capacity of the dump memory block, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

Other features of the present disclosure and advantages thereof will become apparent from the following detailed description of exemplary embodiments of the present disclosure with reference to the accompanying drawings.

### BRIEF DESCRIPTION OF THE DRAWINGS

In order to more clearly illustrate the technical solution in the embodiments of the disclosure, the drawings essential for understanding the disclosed embodiments will be briefly described below. Apparently, the drawings described below are merely some embodiments of the disclosure. For a person skilled in the art, other drawings may be obtained based on the provided drawings without making creative efforts.

FIG. 1 is a flowchart of an information processing method, according to some embodiments of the disclosure;

FIG. 2 is a flowchart of another information processing method, according to some embodiments of the disclosure;

FIG. 3 is a flowchart of another information processing method, according to some embodiments of the disclosure;

FIG. 4 is a flowchart of another information processing method, according to some embodiments of the disclosure;

FIG. 5 is a schematic structural diagram of an information processing apparatus, according to some embodiments of the disclosure; and

FIG. 6 is a schematic structural diagram of an information processing device, according to some embodiments of the disclosure.

### DETAILED DESCRIPTION

In order to enable those skilled in the art to better understand the solutions of the disclosure, the technical solutions in the embodiments of the disclosure will be clearly and thoroughly described below in conjunction with the drawings in the embodiments of the disclosure. Apparently, the described embodiments are merely part of the embodiments of the disclosure, not all of the embodiments. Based on the embodiments in the disclosure, other embodiments obtained by a person skilled in the art without making creative efforts are within the scope of protection of the present disclosure.

The terms “first”, “second”, and so on in the specification and claims of the disclosure and the drawings are used to distinguish different objects, rather than to describe a specific order. In addition, the terms “including” and “comprising” and any variations thereof are intended to cover non-exclusive inclusions. For example, a process, method, system, product, or device that includes a series of steps or units is not limited to the listed steps or units, but optionally includes steps or units that are not listed, or optionally includes other steps or units inherent to these processes, methods, products or devices.

Reference to “an embodiment” herein means that a particular feature, structure, or characteristic described in conjunction with the embodiment may be included in at least one embodiment of the disclosure. The appearance of the phrase in various locations in the specification does not necessarily refer to the same embodiment, nor is it an independent or alternative embodiment that is mutually exclusive with other embodiments. It is explicitly and implicitly understood by those skilled in the art that the embodiments described herein may be combined with other embodiments.

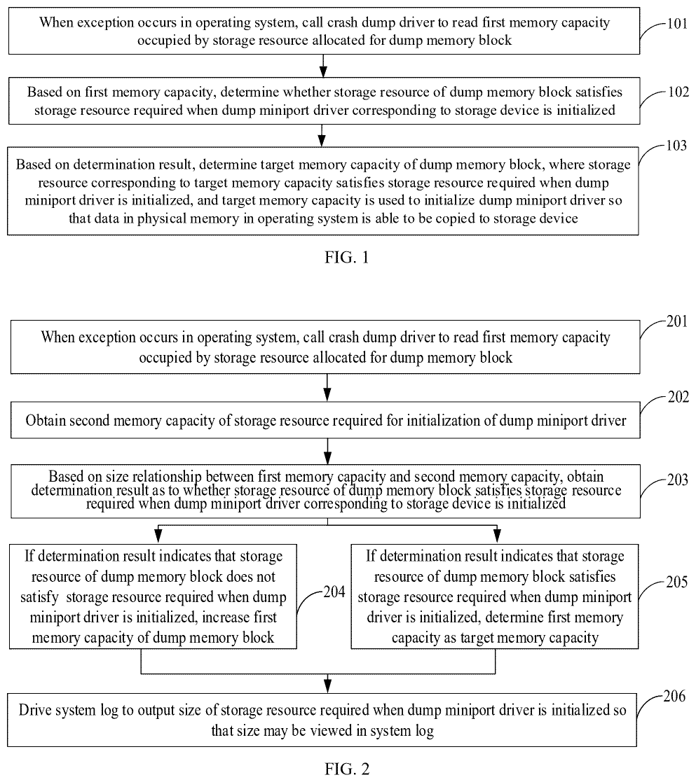

Embodiments of the disclosure provide an information processing method. As shown in FIG. 1, the method includes the following steps.

Step 101: When an exception occurs in an operating system, call a crash dump driver to read a first memory capacity occupied by a storage resource allocated for a dump memory block.

In the embodiments of the disclosure, the crash dump driver may be understood as a driver for capturing and saving the system state at the time of the crash when the operating system crashes or encounters a serious error. The crash dump driver is the core of the entire dump mechanism. When the operating system crashes, the crash dump driver is responsible for starting the dumping process and generating a crash dump file (i.e., a dump file) based on the key data in the memory, so as to dump the crash dump file to an external storage device. The crash dump file records the key information such as the memory state, the running state, the function call stack, and the register values when the operating system crashes.

In some embodiments, the dump memory block is a memory block predefined by the crash dump driver of the operating system, and the dump memory block is used to capture and save memory data related to input/output (I/O) when the operating system crashes.

In some embodiments, the first memory capacity is the space capacity occupied by the storage resource allocated by the crash dump driver for the dump memory block, where the first memory capacity may have a default space capacity size, or may have a space capacity size obtained by adjusting the default space capacity size of the dump memory block once or multiple times, which is not limited in the disclosure. Exemplarily, the default space capacity size of the dump memory block is 16 pages, where the size of each page usually depends on the memory page size of the operating system. In common x86 and x64 architectures, the page size is usually 4 KB.

In some embodiments, before an exception occurs in the operating system, the operating system pre-sets a dump memory block and specifies the size of the storage resource occupied by the dump memory block as a third memory capacity, where the first memory capacity is greater than or equal to the third memory capacity. Here, the third memory capacity may be a pre-defined default space capacity size of the storage resource occupied by the dump memory block. It should be noted that if the first memory capacity is the default space capacity size, the first memory capacity is the same as the third memory capacity. If the first memory capacity is the space capacity size obtained after one or more adjustments, the first memory capacity is different from the third memory capacity.

In the embodiments of the disclosure, an exception of the operating system may be a freeze or crash of the operating system or a blue screen. The operating system in the embodiments of the disclosure is a Windows® operating system, and in other embodiments, the operating system may also be a Linux® operating system or an IOS® operating system.

In some embodiments, the operating system predefines a dump memory block and allocates a storage resource with a default space capacity to the dump memory block. When an exception occurs in the operating system, the operating system automatically initializes and loads a crash dump driver, and reads the first memory capacity of the dump memory block by calling the crash dump driver.

Step 102: Based on the first memory capacity, determine whether the storage resource of the dump memory block satisfies a storage resource required when a dump miniport driver corresponding to the storage device is initialized.

In the embodiments of the disclosure, the dump miniport driver is a dedicated driver on the storage device, which is configured to interact with the crash dump driver. Here, the dump miniport driver is usually provided by the storage device manufacturer to implement the unique functions and optimizations of the storage device. The dump miniport driver may perform special processing or format conversion on the dump data according to the characteristics and requirements of the storage device to ensure that the data may be correctly received and saved by the storage device.

In some embodiments, the storage resource required for initialization of the dump miniport driver corresponding to the storage device may be understood as follows: when the operating system crashes, a crash dump mechanism will start and attempt to initialize the storage miniport driver to collect the necessary dump data from the storage device. During this process, the crash dump mechanism needs to allocate a necessary storage resource to the storage miniport driver to ensure that the driver may perform its tasks.

In the embodiments of the disclosure, the determination result may indicate that the storage resource of the dump memory block satisfies the storage resource required when the dump miniport driver corresponding to the storage device is initialized. The determination result may also indicate that the storage resource of the dump memory block does not satisfy the storage resource required when the dump miniport driver corresponding to the storage device is initialized. It should be noted that when the operating system crashes, if the storage resource of the dump memory block does not satisfy the storage resource required when the dump miniport driver corresponding to the storage device is initialized, the initialization process of the dump miniport driver corresponding to the storage device cannot be completed, resulting in failure to generate a crash dump file.

In some embodiments, when an exception occurs in the operating system and the crash dump driver is called to read the first memory capacity occupied by the storage resource allocated for the dump memory block. A determination result, as to whether the storage resource of the dump memory block satisfies the storage resource required when the dump miniport driver corresponding to the storage device is initialized, may be then determined based on the first memory capacity corresponding to the dump memory block, so as to determine a target memory capacity of the dump memory block according to the determination result.

Step 103: Based on the determination result, determine a target memory capacity of the dump memory block, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

In the embodiments of the disclosure, the target memory capacity is a capacity size determined based on the determination result and the first memory capacity.

In the embodiments of the disclosure, the data in the physical memory records key information such as the memory state, running state, function call stack, register values, etc., when the operating system crashes.

In some embodiments, based on the first memory capacity, obtain a determination result as to whether the storage resource of the dump memory block satisfies the storage resource required when the dump miniport driver corresponding to the storage device is initialized. Based on the determination result and the first memory capacity, the target memory capacity of the dump memory block may be determined, so that the storage resource corresponding to the target memory capacity may satisfy the storage resource required when the dump miniport driver is initialized, so that the dump miniport driver may be initialized subsequently. This then allows the data in the physical memory of the operating system containing key information such as the memory state, running state, function call stack, register values, etc., to be copied to the storage device when the operating system crashes. In this way, a crash dump file may be successfully generated, and subsequently, developers and technical support personnel use the crash dump file to analyze and locate exception problems.

Embodiments of the disclosure provide an information processing method. When an exception occurs in the operating system, call a crash dump driver to read the first memory capacity occupied by the storage resource allocated for the dump memory block. In this way, when the operating system crashes abnormally, by calling the crash dump driver to read the memory dump information, the operating status and memory data before the system crash may be fully recorded. This provides data for subsequent analysis of the cause of the exception and locating the root cause of the problem, thereby improving the efficiency of fault diagnosis. Further, based on the first memory capacity, a determination result is obtained as to whether the storage resource of the dump memory block satisfies the storage resource required when the dump miniport driver corresponding to the storage device is initialized. Based on the determination result, the target memory capacity of the dump memory block is determined. In this way, based on the first memory capacity, determine and adjust the first memory capacity to the target memory capacity, thereby ensuring that the dump miniport driver can be successfully initialized. This allows to fully utilize the storage device resources for effective data dumping, avoiding the problem that the key data cannot be completely saved due to insufficient storage resources. Further, after determining the target memory capacity that satisfies the requirements of the dump miniport driver, all key data in the physical memory of the operating system is able to be copied to an external storage device under abnormal circumstances, so that the integrity of the data may be maintained after the system crashes, which helps to quickly restore system services or retrieve lost data. Finally, by timely dumping and analyzing memory data at the time of the crash, the system design may be continuously optimized and improved, and the overall stability and reliability of the operating system may be improved.

Embodiments of the disclosure provide another information processing method. As shown in FIG. 2, the method includes the following steps.

Step 201: When an exception occurs in an operating system, call a crash dump driver to read a first memory capacity occupied by a storage resource allocated for a dump memory block.

Step 202: Obtain a second memory capacity of a storage resource required for the initialization of a dump miniport driver.

In some embodiments, the parameters used for initialization in a storage miniport driver include a device extension field, which is usually customized by the manufacturer of the storage device. The device extension field is a structure used to implement functions that are exclusive to the storage card or storage device, and the size of the structure may vary depending on the manufacturer's design and functional requirements. In one case, the design of the device extension field structure allows the storage manufacturer to add specific fields and functions to a dump miniport driver to satisfy the needs of a specific storage card. For example, the field may include parameters and settings related to the performance, security, management, or other proprietary features of the card.

In the embodiments of the disclosure, the second memory capacity may be understood as the memory capacity of the storage resource required for initializing the device extension field in the dump miniport driver. It should be noted that the second memory capacity is the same or consistent with the size capacity of the structure of the device extension field.

In actual applications, since the device extension field is customized by the storage manufacturer, the size and content of the device extension field may vary. Different memory cards or storage devices may have different device extension field structures to support their unique features and functions. By implementing these extension fields, storage manufacturers may provide more flexible and personalized solutions to satisfy the needs of different users. At the same time, this also provides more possibilities for storage devices, making them have better performance, compatibility, security, etc.

In some embodiments, when an exception occurs in the operating system, after calling the crash dump driver to read the first memory capacity occupied by the storage resource allocated for the dump memory block, a second memory capacity of the storage resource required when the dump miniport driver is initialized may also be obtained. That is, the second memory capacity of the storage resource required when the device extension field in the dump miniport driver is initialized is obtained.

Step 203: Based on the size relationship between the first memory capacity and the second memory capacity, obtain a determination result as to whether the storage resource of the dump memory block satisfies the storage resource required when the dump miniport driver corresponding to the storage device is initialized.

In some embodiments, the first memory capacity is the memory capacity of the dump memory block, and the second memory capacity is the memory capacity of the device extension field. The first memory capacity of the dump memory block is used to allocate a storage resource for the second memory capacity required for the device extension field, so that based on the first memory capacity, the storage miniport driver may be allocated a storage resource required when initializing.

In actual applications, when the system crashes, some operations of the normal file system in the system are no longer reliable. At this moment, the storage miniport driver of the storage device may establish its own I/O operation method by comparing the first memory capacity of the dump memory block and the second memory capacity of the device extension field. If the first memory capacity is greater than the second memory capacity, the first memory capacity may be used to allocate the storage resource requested when the storage miniport driver is initialized, so that the storage miniport driver may be reloaded in the quickest way when the system crashes. Since the system is relatively normal at this moment, the data in the physical memory is able to be copied to the storage device through the I/O operation established by the storage miniport driver.

In some embodiments, Step 203 of obtaining the determination result as to whether the storage resource of the dump memory block satisfies the storage resource required when the dump miniport driver corresponding to the storage device is initialized based on the size relationship between the first memory capacity and the second memory capacity may be obtained through the following.

When there is a first size relationship between the first memory capacity and the second memory capacity, obtain a determination result indicating that the storage resource of the dump memory block does not satisfy the storage resource required when the dump miniport driver is initialized.

When the first size relationship does not exist between the first memory capacity and the second memory capacity, obtain a determination result indicating that the storage resource of the dump memory block satisfies the storage resource required when the dump miniport driver is initialized.

In the embodiments of the disclosure, the first size relationship is that the second memory capacity is greater than the first memory capacity. The second memory capacity being greater than the first memory capacity may be understood as, since the first memory capacity is less than or equal to the second memory capacity, the storage miniport driver cannot be allocated the requested storage resource when the storage miniport driver is initialized, resulting in a failure to load the storage miniport driver. This then affects the storage of the crash dump file, resulting in a failure of the generation and storage of the crash dump file. Alternatively, since the first memory capacity is less than or equal to the second memory capacity, the storage miniport driver may occupy the memory resource of other programs when the storage miniport driver is initialized, resulting in an exception in the instructions executed by the central processing unit and causing the system to crash.

In the embodiments of the disclosure, if the second memory capacity is greater than the first memory capacity, that is, there is a first size relationship between the first memory capacity and the second memory capacity, then, based on the first memory capacity of the dump memory block, the storage miniport driver cannot be allocated the requested storage resource when initializing, so that the storage resource of the dump memory block does not satisfy the storage resource required when the dump miniport driver is initialized. On the other hand, if the second memory capacity is less than or equal to the first memory capacity, that is, the first size relationship does not exist between the first memory capacity and the second memory capacity, then, based on the first memory capacity of the dump memory block, the storage miniport driver can be allocated the requested storage resource when initializing, so that the storage resource of the dump memory block satisfies the storage resource required when the dump miniport driver is initialized.

Step 204: If the determination result indicates that the storage resource of the dump memory block does not satisfy the storage resource required when the dump miniport driver is initialized, increase the first memory capacity of the dump memory block.

Here, the increased first memory capacity is the target memory capacity, where a storage resource corresponding to the target memory capacity satisfies the storage resource required when the dump miniport driver is initialized. The target memory capacity is used to initialize the dump miniport driver so that the data in the physical memory in the operating system is able to be copied to the storage device.

In actual applications, in an operating system, increasing the memory capacity of the dump memory block usually needs to be configured at the operating system level. Increasing the memory capacity of the dump memory block involves modifying system parameters or settings to allow a greater memory dump file to be created. In an achievable scenario, increasing the memory capacity of the dump memory block may be done by modifying the “Startup and Recovery” settings in the system properties to increase the size of the dump memory block. Apparently, the dump option of increasing the size of the dump memory block may also be further configured by editing the registries or using group policies.

In some embodiments, when the determination result indicates that the storage resource of the dump memory block does not satisfy the storage resource required when the dump miniport driver is initialized, the first memory capacity of the dump memory block is increased, and the increased first memory capacity is greater than the second memory capacity corresponding to the device extension field in the storage device. Then, the increased first memory capacity is determined as the target memory capacity, so that the storage resource corresponding to the target memory capacity may satisfy the storage resource required when the dump miniport driver is initialized, so that the dump miniport driver may be initialized subsequently. The data in the physical memory of the operating system containing key information, such as the memory state, running state, function call stack, register values, etc., when the operating system crashes, may then be copied to the storage device. In this way, the crash dump file may be successfully generated, and subsequently, developers and technical support personnel may use the crash dump file to analyze and locate exception problems.

Step 205: If the determination result indicates that the storage resource of the dump memory block satisfies the storage resource required when the dump miniport driver is initialized, determine the first memory capacity as the target memory capacity.

Here, the storage resource corresponding to the target memory capacity satisfies the storage resource required when the dump miniport driver is initialized, and the target memory capacity is used to initialize the dump miniport driver so that data in the physical memory of the operating system is able to be copied to the storage device.

In some embodiments, when the determination result indicates that the storage resource of the dump memory block satisfies the storage resource required when the dump miniport driver is initialized, the first memory capacity may be determined as the target memory capacity, so that the storage resource corresponding to the target memory capacity may satisfy the storage resource required when the dump miniport driver is initialized, so that the dump miniport driver may be initialized subsequently. The data in the physical memory of the operating system containing key information such as the memory state, running state, function call stack, register values, etc., is able to be copied to the storage device when the operating system crashes. In this way, the crash dump file may be successfully generated, and subsequently, developers and technical support personnel may use the crash dump file to analyze and locate exception problems.

Step 206: Drive a system log to output a size of the storage resource required when the dump miniport driver is initialized so that the size may be viewed in the system log.

In the embodiments of the disclosure, after determining the target memory capacity, the system log in the operating system may also be driven to output the size of the storage resource required when the dump miniport driver is initialized, so that the second memory capacity of the device extension field is recorded in the system log, and the developers and technical support personnel may view the second memory capacity of the device extension field in the system log. Since the size of the dump memory block ultimately determines the structural length of the device extension field in the storage miniport driver, the second memory capacity is compared with the first memory capacity of the dump memory block. In this way, if the second memory capacity is greater than the first memory capacity, it may be identified that the storage miniport driver cannot allocate the requested resource when initializing due to the small memory capacity of the dump memory block, thereby causing the storage miniport driver to fail to load and then causing the system to crash. Apparently, if the second memory capacity is not greater than the first memory capacity, the data in the physical memory of the operating system copied by the storage device (i.e., the crash dump file) may also be analyzed to locate the problem that causes the system to crash, so as to improve the efficiency of locating the problem.

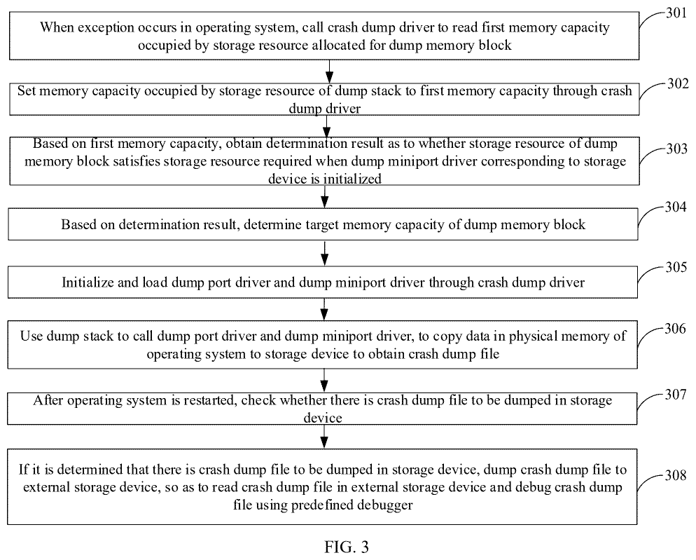

Embodiments of the disclosure provide another information processing method. As shown in FIG. 3, the method includes the following steps.

Step 301: When an exception occurs in an operating system, call a crash dump driver to read a first memory capacity occupied by a storage resource allocated for a dump memory block.

Step 302: Set a memory capacity occupied by a storage resource of the dump stack to the first memory capacity through a crash dump driver.

In the embodiments of the disclosure, the dump stack is used to manage the data and information in the dumping process. The dump stack is a data structure with a certain memory capacity. In practical applications, the stack is often used to implement the last-in-first-out (LIFO) operation, which is particularly important in the dumping process because it is necessary to ensure the integrity and consistency of the data. The dump stack may effectively store and manage temporary variables, return addresses and other information in the dumping process to ensure the smooth progress of the dumping operation.

In some embodiments, when an exception occurs in the operating system, the crash dump driver is called to read the first memory capacity occupied by the storage resource allocated for the dump memory block. A memory resource is allocated to the dump stack based on the memory capacity of the dump memory block. That is, the memory capacity occupied by the storage resource of the dump stack is set to the first memory capacity of the dump memory block. In this way, temporary variables, return addresses and other information in the dumping process are stored and managed through the dump stack with the first memory capacity, so that memory resources are reasonably allocated while ensuring the smooth progress of the dumping operation.

Step 303: Based on the first memory capacity, obtain a determination result as to whether the storage resource of the dump memory block satisfies the storage resource required when the dump miniport driver corresponding to the storage device is initialized.

Step 304: Based on the determination result, determine a target memory capacity of the dump memory block.

Here, the storage resource corresponding to the target memory capacity satisfies the storage resource required when the dump miniport driver is initialized, and the target memory capacity is used to initialize the dump miniport driver so that data in the physical memory of the operating system is able to be copied to the storage device.

Step 305: Initialize and load a dump port driver and a dump miniport driver through the crash dump driver.

Step 306: Use the dump stack to call the dump port driver and the dump miniport driver, to copy data in a physical memory of the operating system to the storage device to obtain a crash dump file.

In the embodiments of the disclosure, the dump port driver is used to provide an interface and protocol for communicating with the storage device, ensuring that the crash dump driver may correctly interact with the storage device to complete the data dumping operation. Thus, the dump port driver connects the crash dump driver and the storage device, playing the role of a bridge.

In the embodiments of the disclosure, after the memory capacity occupied by the storage resource of the dump stack is set to the first memory capacity by the crash dump driver, based on the first memory capacity, a determination result is obtained as to whether the storage resource of the dump memory block satisfies the storage resource required when the dump miniport driver corresponding to the storage device is initialized. Based on the determination result, the target memory capacity of the dump memory block is determined. Further, the dump port driver and the dump miniport driver are initialized and loaded by the crash dump driver, so as to perform the dumping process. In the dumping process, the dump stack is used to manage the function call and variable information in the dumping process. At the same time, the dump port driver and the dump miniport driver participate in the communication and interaction with the hardware device(s), that is, the dump port driver provides an interface for communicating with the storage device, and the dump miniport driver implements the interaction with the storage device's proprietary functions, ensuring that the dump data in the physical memory of the operating system is able to be correctly written to the storage device, thereby obtaining a crash dump file. In this way, the crash dump file may be effectively captured and saved when the system crashes, providing strong support for subsequent fault analysis and debugging.

Step 307: After the operating system is restarted, check whether there is a crash dump file to be dumped in the storage device.

Step 308: If it is determined that there is a crash dump file to be dumped in the storage device, dump the crash dump file to an external storage device, so as to read the crash dump file in the external storage device and debug the crash dump file using a predefined debugger.

In the embodiments of the disclosure, after obtaining the crash dump file, the operating system will restart. Further, the operating system checks whether there is a crash dump file to be dumped. If it is determined that there is a crash dump file to be dumped in the storage device, the operating system reads the crash dump file stored in the storage device and moves the crash dump file from the storage device to another designated external storage device such as a hard disk, thereby ensuring the reliability and security of the dump data. Further, the crash dump file in the external storage device is read, and the crash dump file is debugged using a predefined debugger, so that the cause of the system crash may be accurately analyzed and an alarm may be issued, thereby improving the efficiency of dump file management.

In a possible application scenario, when using certain types of storage devices to install the Windows system, the dump file generation may fail when the system crashes. When customers encounter this type of problem, they cannot provide a valid crash dump file to further locate the problem. Once this type of problem occurs, the crash dump file cannot be stored on any storage device, making it very difficult to locate and find the root cause of the problem. Without the user's crash dump file, it is not possible to help customers solve the problem.

In the existing technologies, in order to solve the above problems, users configure a serial port adapter, a USB to serial port cable, or a network card that supports network debugging to collect crash dump files through Windows debugging tools. This solution has at least the following problems: users may not have a serial port adapter, a USB to serial port cable, or a network card that supports network debugging; collecting crash dump files through the serial port is very slow, requiring 4-5 days or even a week; and it is difficult for users to configure serial port and network card debugging and collect crash dump files through Windows debugging tools.

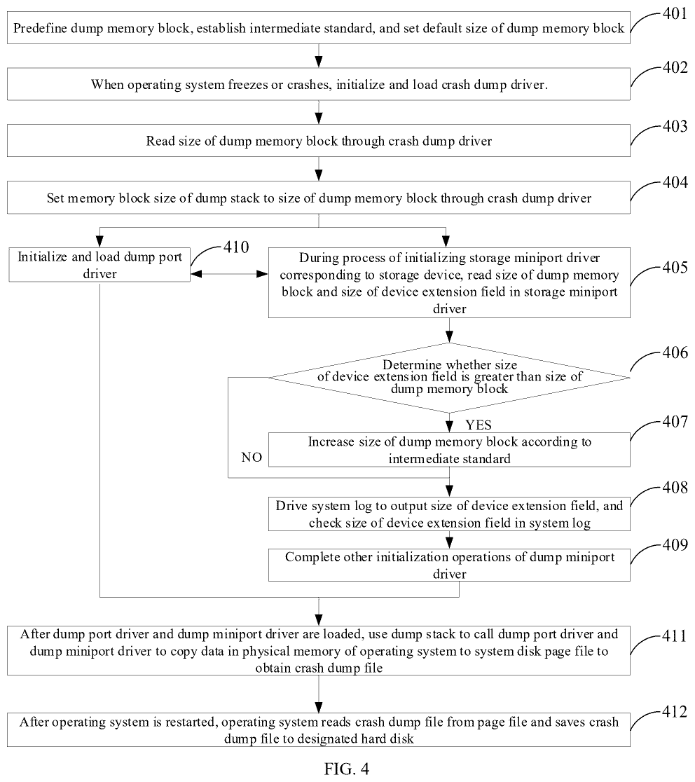

In order to solve the above technical problems, embodiments of the disclosure provide another information processing method. As shown in FIG. 4, the method includes the following steps.

Step 401: Predefine a dump memory block, establish an intermediate standard, and set a default size of the dump memory block.

Here, the size of the dump memory block determines the length of the extension field structure in the storage miniport driver.

The intermediate standard is used to coordinate the operating system and the storage miniport driver in the storage device, and the intermediate standard may be the size of the dump memory block, which is greater than or equal to the size of the device extension field in the storage miniport driver.

Step 402: When the operating system freezes or crashes, initialize and load a crash dump driver.

Step 403: Read the size of the dump memory block through the crash dump driver.

Step 404: Set the memory block size of a dump stack to the size of the dump memory block through the crash dump driver.

Step 405: During a process of initializing the storage miniport driver corresponding to the storage device, read the size of the dump memory block and the size of the device extension field in the storage miniport driver.

Step 406: Determine whether the size of the device extension field is greater than the size of the dump memory block.

In the embodiments of the disclosure, if the size of the device extension field is greater than the size of the dump memory block, it indicates that the size of the dump memory block does not satisfy the size requirement of the device extension field, proceed to Step 407. If the size of the device extension field is not greater than the size of the dump memory block, proceed to Step 408.

Step 407: Increase the size of the dump memory block according to the intermediate standard.

Here, the size of the increased dump memory block is greater than the size of the device extension field, thereby ensuring that when a crash occurs, the storage miniport driver may be allocated the required resource when the storage miniport driver is initialized, so as to generate a dump crash file.

Step 408: Drive a system log to output the size of the device extension field, and check the size of the device extension field in the system log.

Here, developers and technical support personnel may check the size of the device extension field in the system log. Since the size of the dump memory block ultimately determines the structural length of the device extension field in the storage miniport driver, the size of the device extension field is compared with the default size of the dump memory block. In this way, if the size of the device extension field is greater than the default size of the dump memory block, it may be identified that the storage miniport driver cannot allocate the requested resource during initialization due to the small memory capacity of the dump memory block, thereby causing the storage miniport driver to fail to load and then causing the system to crash. Apparently, if the size of the device extension field is not greater than the default size of the dump memory block, after the data in the physical memory of the operating system is copied to the storage device, that is, after the crash dump file is generated, the crash dump file may be analyzed to locate the problem that caused the system crash, thus improving the efficiency of locating the problem.

Step 409: Complete other initialization operations of the dump miniport driver.

Here, other initialization operations of the dump miniport driver include but are not limited to the completion of extended data initialization, configuration, initialization of the adapter, enabling interrupt routines for completing I/O operations, etc.

Step 410: Initialize and load the dump port driver.

Step 411: After the dump port driver and the dump miniport driver are loaded, use the dump stack to call the dump port driver and the dump miniport driver to copy the data in the physical memory of the operating system to a system disk page file to obtain a crash dump file.

Here, the system disk page file usually refers to a special file created by the operating system when the system crashes. It is used to save key data in the physical memory when the system crashes. The page file is usually a .dmp file.

Here, the crash dump driver is a specific driver that is configured to capture and save a crash dump file when the system crashes. The crash dump file contains the memory state and other related information when the system crashes, which is crucial for subsequent system failure analysis and debugging.

Here, the dump stack is a data structure configured to manage data and information during the dumping process. In computers, stacks are often used to implement the LIFO operations, which is especially important during the dumping process because the integrity and consistency of the data need to be ensured. The dump stack may effectively store and manage temporary variables, return addresses, and other information during the dumping process to ensure the smooth progress of the dumping operation.

Here, the dump port driver and dump miniport driver are more specific types of drivers. The dump port driver is usually related to a specific hardware interface or bus protocol, and the dump port driver is responsible for handling communication and interaction with hardware devices. The dump miniport driver is a more refined device driver that interacts directly with a specific hardware device and provides fine control and management of that hardware device.

In the embodiments of the disclosure, when the operating system crashes, the crash dump driver is triggered to capture the memory dump file. In the dumping process, the dump stack is used to manage relevant data and information. Simultaneously, the dump port driver and the dump miniport driver communicate and interact with the hardware device(s) to ensure the smooth progress of the dumping operation. These components work together to ensure that the dump file may be effectively captured and saved when the operating system crashes, providing powerful support for subsequent fault analysis and debugging.

Step 412: After the operating system is restarted, the operating system reads the crash dump file from the page file and saves the crash dump file to a designated hard disk.

Here, after the operating system restarts, the operating system will check whether there is an unprocessed crash dump file. The operating system will read the page file previously saved on the system disk (i.e., the crash dump file). In order to ensure the reliability and accessibility of the data, the operating system may move the dump file from the system disk to another designated hard disk or storage device. In this way, even when there is a problem with the system disk, the dump file will not be lost. Furthermore, developers or technicians may use the crash dump file to analyze the cause of the system crash and take appropriate measures to solve the problem.

As can be seen from the above, the embodiments of the disclosure ensure that the crash dump file may be successfully saved when the operating system crashes when the storage device functions become more and more powerful. Users do not need to prepare hardware devices such as serial port adapters, USB to serial port cables, network cards that support network debugging, etc. Users do not need to learn complex debugging knowledge to save crash dump files. It is convenient to help customers actively and efficiently locate problems, reduce customer complaints and dissatisfaction, and improve customer satisfaction.

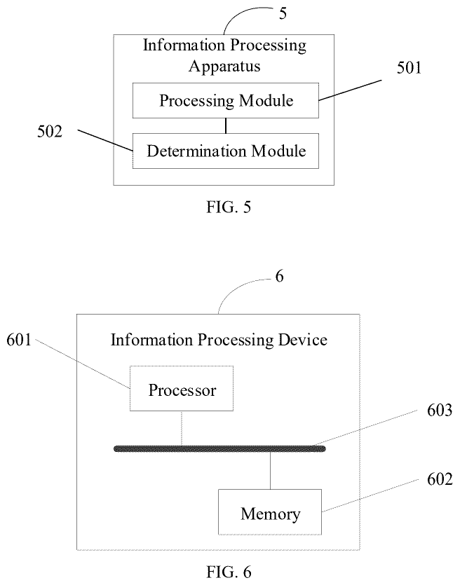

Embodiments of the disclosure further provide an information processing apparatus, which may be configured to implement information processing methods provided by the embodiments corresponding to FIG. 1, FIG. 2, and FIG. 3. As shown in FIG. 5, the information processing apparatus 5 includes the following.

A processing module, which is configured to call a crash dump driver to read a first memory capacity occupied by a storage resource allocated for a dump memory block when an exception occurs in an operating system.

A determination module 502, which is configured to obtain, based on the first memory capacity, a determination result as to whether the storage resource of the dump memory block satisfies a storage resource required when a dump miniport driver corresponding to the storage device is initialized.

The determination module 502 is further configured to determine a target memory capacity of the dump memory block based on the determination result, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

In some embodiments, the determination module 502 is further used to obtain a second memory capacity of the storage resource required when the dump miniport driver is initialized, and obtain the determination result based on a size relationship between the first memory capacity and the second memory capacity.

In some embodiments, the determination module 502 is further configured to obtain a determination result indicating that the storage resource of the dump memory block does not satisfy the storage resource required when the dump miniport driver is initialized when there is a first size relationship between the first memory capacity and the second memory capacity; and to obtain a determination result indicating that the storage resource of the dump memory block satisfies the storage resource required when the dump miniport driver is initialized when the first size relationship does not exist between the first memory capacity and the second memory capacity.

In some embodiments, the determination module 502 is further configured to increase the first memory capacity of the dump memory block if the determination result indicates that the storage resource of the dump memory block does not satisfy the storage resource required when the dump miniport driver is initialized, where the increased first memory capacity is the target memory capacity. If the determination result indicates that the storage resource of the dump memory block satisfies the storage resource required when the dump miniport driver is initialized, determine the first memory capacity as the target memory capacity.

In some embodiments, the processing module 501 is further configured to drive a system log to output the size of the storage resource required when the dump miniport driver is initialized so that the size may be viewed in the system log.

In some embodiments, the processing module 501 is further configured for the operating system to pre-set a dump memory block and specify the size of the storage resource occupied by the dump memory block as a third memory capacity, where the first memory capacity is greater than or equal to the third memory capacity.

In some embodiments, the processing module 501 is further configured to set the memory capacity occupied by the storage resource of the dump stack to the first memory capacity through the crash dump driver; initialize and load the dump port driver and the dump miniport driver through the crash dump driver; and use the dump stack to call the dump port driver and the dump miniport driver to copy the data in the physical memory in the operating system to the storage device to obtain a crash dump file.

In some embodiments, the processing module 501 is further configured to check whether there is a crash dump file to be dumped in the storage device after the operating system is restarted; and if it is determined that there is a crash dump file to be dumped in the storage device, dump the crash dump file to an external storage device, so as to read the crash dump file in the external storage device and debug the crash dump file using a predefined debugger.

Based on the above embodiments, an information processing device may be configured for information processing methods provided by the embodiments corresponding to FIG. 1, FIG. 5, and FIG. 6. As shown in FIG. 6, the information processing device 6 (which corresponds to the information processing apparatus 5 in FIG. 5) includes a processor 601, a memory 602 and a communication bus 603.

The communication bus 603 is configured to realize the communication connection between the processor 601 and the memory 602.

The processor is configured to execute an information processing program(s) stored in the memory 602 to implement the following step(s).

When an exception occurs in an operating system, call a crash dump driver to read a first memory capacity occupied by a storage resource allocated for a dump memory block.

Based on the first memory capacity, obtain a determination result as to whether the storage resource of the dump memory block satisfies a storage resource required when a dump miniport driver corresponding to the storage device is initialized.

Based on the determination result, determine a target memory capacity of the dump memory block, where a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

In some embodiments, the processor 601 is further configured to execute an information processing program(s) stored in the memory 602 to implement the following step(s).

Obtain a second memory capacity of the storage resource required for initializing the dump miniport driver; and obtain the determination result based on a size relationship between the first memory capacity and the second memory capacity.

In some embodiments, the processor 601 is further configured to execute an information processing program(s) stored in the memory 602 to implement the following step(s).

When there is a first size relationship between the first memory capacity and the second memory capacity, obtain a determination result indicating that the storage resource of the dump memory block does not satisfy the storage resource required when the dump miniport driver is initialized.

When the first size relationship does not exist between the first memory capacity and the second memory capacity, obtain a determination result indicating that the storage resource of the dump memory block satisfies the storage resource required when the dump miniport driver is initialized.

In some embodiments, the processor 601 is further configured to execute an information processing program(s) stored in the memory 602 to implement the following step(s).

If the determination result indicates that the storage resource of the dump memory block does not satisfy the storage resource required when the dump miniport driver is initialized, increase the first memory capacity of the dump memory block, where the increased first memory capacity is the target memory capacity.

If the determination result indicates that the storage resource of the dump memory block satisfies the storage resource required when the dump miniport driver is initialized, determine the first memory capacity as the target memory capacity.

In some embodiments, the processor 601 is further configured to execute an information processing program(s) stored in the memory 602 to implement the following step(s).

Drive the system log to output the size of the storage resource required when the dump miniport driver is initialized so that the size may be viewed in the system log.

In some embodiments, the processor 601 is further configured to execute an information processing program(s) stored in the memory 602 to implement the following step(s).

The operating system pre-sets a dump memory block and specifies the size of the storage resource occupied by the dump memory block as a third memory capacity, where the first memory capacity is greater than or equal to the third memory capacity.

In some embodiments, the processor 601 is further configured to execute an information processing program(s) stored in the memory 602 to implement the following step(s).

Set, by the crash dump driver, the memory capacity occupied by the storage resource of the dump stack to the first memory capacity.

Initialize and load the dump port driver and dump miniport driver through the crash dump driver.

Use the dump stack to call the dump port driver and the dump miniport driver to copy the data in the physical memory of the operating system to the storage device to obtain a crash dump file.

In some embodiments, the processor 601 is further configured to execute an information processing program(s) stored in the memory 602 to implement the following step(s).

After the operating system is restarted, check whether there is a crash dump file to be dumped in the storage device.

If it is determined that there is a crash dump file to be dumped in the storage device, dump the crash dump file to an external storage device, so as to read the crash dump file in the external storage device and debug the crash dump file using a predefined debugger.

The methods provided in the embodiments of the disclosure may be directly embodied as a combination of software modules executed by the processor 601. The software modules may be located in a storage medium, and the storage medium is located in the memory 602. The processor 601 reads the executable instructions included in the software modules in the memory 602, and implements the methods provided in the embodiments of the disclosure in combination with the necessary hardware.

As an example, the processor 601 may be an integrated circuit chip with signal processing capabilities, such as a general-purpose processor, a digital signal processor (DSP), or other programmable logic devices, discrete gate or transistor logic devices, discrete hardware components, etc., where the general-purpose processor may be a microprocessor or any conventional processor, etc.

It should be noted that the specific implementation process of the steps executed by the processor in the embodiments disclosed herein may refer to the implementation processes in the information display methods provided in the corresponding embodiments of FIGS. 1 to 3, which will not be repeated here.

Embodiments of the disclosure further provide a non-transitory storage medium storing a computer program. When the computer program is executed by at least one processor, the implementation processes of the information processing methods provided in the embodiments corresponding to FIGS. 1 to 3 are executed, which will not be repeated here.

Embodiments of the disclosure further provide a computer program product, including a computer program or instructions. When the computer program or instructions are executed by a processor, the implementation processes of the information processing methods provided in the embodiments corresponding to FIGS. 1 to 3 are executed, which will not be repeated here.

Embodiments of the disclosure provide an information processing method, an information processing apparatus, and an information processing device. When an exception occurs in the operating system, call a crash dump driver to read the first memory capacity occupied by the storage resource allocated for the dump memory block. In this way, when the operating system crashes abnormally, by calling the crash dump driver to read the memory dump information, the operating status and memory data before the system crash may be fully recorded. This provides data for subsequent analysis of the cause of the exception and locating the root cause of the problem, thereby improving the efficiency of fault diagnosis. Further, based on the first memory capacity, a determination result is obtained as to whether the storage resource of the dump memory block satisfies the storage resource required when the dump miniport driver corresponding to the storage device is initialized. Based on the determination result, the target memory capacity of the dump memory block is determined. In this way, based on the first memory capacity, determine and adjust the first memory capacity to the target memory capacity, thereby ensuring that the dump miniport driver can be successfully initialized. This allows to fully utilize the storage device resources for effective data dumping, avoiding the problem that the key data cannot be completely saved due to insufficient storage resources. Further, after determining the target memory capacity that satisfies the requirements of the dump miniport driver, all key data in the physical memory of the operating system is able to be copied to an external storage device under abnormal circumstances, so that the integrity of the data may be maintained after the system crashes, which helps to quickly restore system services or retrieve lost data. Finally, by timely dumping and analyzing memory data at the time of the crash, the system design may be continuously optimized and improved, and the overall stability and reliability of the operating system may be improved.

Those skilled in the art will appreciate that the embodiments of the disclosure may be provided as methods, systems, or computer program products. Therefore, the disclosure may take the form of hardware embodiments, software embodiments, or embodiments combining software and hardware. Moreover, the disclosure may take the form of a computer program product implemented on one or more computer-executable storage media (including but not limited to disk storage and optical storage, etc.) containing computer-executable program codes.

The disclosure is described with reference to the flowcharts and/or block diagrams of the methods, devices (apparatuses), and computer program products according to the embodiment of the disclosure. It should be understood that each process and/or block in the flowcharts and/or block diagrams, as well as the combination of the process and/or block in the flowcharts and/or block diagrams may be implemented by computer program instructions. These computer program instructions may be provided to a processor of a general-purpose computer, a special-purpose computer, an embedded processor, or other programmable data processing devices to generate a machine, so that the instructions executed by the processor of the computer or other programmable data processing devices generate a device for implementing the functions specified in one process or multiple processes in the flowcharts and/or one block or multiple blocks in the block diagrams.

These computer program instructions may also be stored in a computer-readable memory that may direct a computer or other programmable data processing devices to work in a specific manner, so that the instructions stored in the computer-readable memory produce a manufactured product including an instruction device that implements the functions specified in one or more processes in the flowcharts and/or one or more blocks in the block diagrams.

These computer program instructions may also be loaded onto a computer or other programmable data processing devices so that a series of operational steps are executed on the computer or other programmable devices to create a computer-implemented process, whereby the instructions executed on the computer or other programmable devices provide steps for implementing the functions specified in one or more processes in the flowcharts and/or one or more blocks in the block diagrams.

The above description includes merely some embodiments of the disclosure and is not intended to limit the protection scope of the disclosure.

What is claimed is:

1. An information processing method, comprising:
when an exception occurs in an operating system, calling a crash dump driver to read a first memory capacity occupied by a storage resource allocated for a dump memory block;
based on the first memory capacity, obtaining a determination result as to whether the storage resource of the dump memory block satisfies a storage resource required when a dump miniport driver corresponding to a storage device is initialized; and
based on the determination result, determining a target memory capacity of the dump memory block, wherein a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

2. The method according to claim 1, wherein the determining result as to whether the storage resource of the dump memory block satisfies the storage resource required when the dump miniport driver corresponding to the storage device is initialized based on the first memory capacity comprises:
obtaining a second memory capacity of the storage resource required when the dump miniport driver is initialized; and
obtaining the determination result based on a size relationship between the first memory capacity and the second memory capacity.

3. The method according to claim 2, wherein obtaining the determination result based on the size relationship between the first memory capacity and the second memory capacity comprises:
when there is a first size relationship between the first memory capacity and the second memory capacity, obtaining a determination result indicating that the storage resource of the dump memory block does not satisfy the storage resource required when the dump miniport driver is initialized; and
when the first size relationship does not exist between the first memory capacity and the second memory capacity, obtaining a determination result indicating that the storage resource of the dump memory block satisfies the storage resource required when the dump miniport driver is initialized.

4. The method according to claim 1, wherein determining the target memory capacity of the dump memory block based on the determination result comprises:
when the determination result indicates that the storage resource of the dump memory block does not satisfy the storage resource required when the dump miniport driver is initialized, increasing the first memory capacity of the dump memory block, wherein the increased first memory capacity is the target memory capacity; and
when the determination result indicates that the storage resource of the dump memory block satisfies the storage resource required when the dump miniport driver is initialized, determining the first memory capacity to be the target memory capacity.

5. The method according to claim 1, further comprising:
driving a system log to output a size of the storage resource required when the dump miniport driver is initialized so that the size is able to be viewed in the system log.

6. The method according to claim 1, wherein, before the exception in the operating system, the method further comprises:
pre-setting, by the operating system, the dump memory block, and specifying, by the operating system, a size of a storage resource occupied by the dump memory block as a third memory capacity, wherein the first memory capacity is greater than or equal to the third memory capacity.

7. The method according to claim 1, wherein:
after calling the crash dump driver to read the first memory capacity occupied by the storage resource allocated for the dump memory block, the method includes:
setting, by the crash dump driver, a memory capacity occupied by a storage resource of a dump stack to the first memory capacity; and
after determining the target memory capacity of the dump memory block based on the determination result, the method includes:
initializing and loading a dump port driver and the dump miniport driver through the crash dump driver; and
using the dump stack to call the dump port driver and the dump miniport driver, to copy the data in the physical memory in the operating system to the storage device to obtain a crash dump file.

8. The method according to claim 7, further comprising:
after the operating system is restarted, checking whether there is a crash dump file to be dumped in the storage device; and
when it is determined that there is a crash dump file to be dumped in the storage device, dumping the to-be-dumped crash dump file to an external storage device, so as to read the dumped crash dump file in the external storage device and debug the crash dump file using a predefined debugger.

9. An information processing device, including a memory and one or more processors, wherein the memory stores a computer program executable by the one or more processors, and when executing the computer program, the one or more processors are configured to perform:
when an exception occurs in an operating system, calling a crash dump driver to read a first memory capacity occupied by a storage resource allocated for a dump memory block;
based on the first memory capacity, obtaining a determination result as to whether the storage resource of the dump memory block satisfies a storage resource required when a dump miniport driver corresponding to a storage device is initialized; and
based on the determination result, determining a target memory capacity of the dump memory block, wherein a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

10. The information processing device according to claim 9, wherein the one or more processors are further configured to perform:
obtaining a second memory capacity of the storage resource required when the dump miniport driver is initialized; and
obtaining the determination result based on a size relationship between the first memory capacity and the second memory capacity.

11. The information processing device according to claim 10, wherein the one or more processors are further configured to perform:
when there is a first size relationship between the first memory capacity and the second memory capacity, obtaining a determination result indicating that the storage resource of the dump memory block does not satisfy the storage resource required when the dump miniport driver is initialized; and
when the first size relationship does not exist between the first memory capacity and the second memory capacity, obtaining a determination result indicating that the storage resource of the dump memory block satisfies the storage resource required when the dump miniport driver is initialized.

12. The information processing device according to claim 9, wherein the one or more processors are further configured to perform:
when the determination result indicates that the storage resource of the dump memory block does not satisfy the storage resource required when the dump miniport driver is initialized, increasing the first memory capacity of the dump memory block, wherein the increased first memory capacity is the target memory capacity; and
when the determination result indicates that the storage resource of the dump memory block satisfies the storage resource required when the dump miniport driver is initialized, determining the first memory capacity to be the target memory capacity.

13. The information processing device according to claim 9, wherein the one or more processors are further configured to perform:
driving a system log to output a size of the storage resource required when the dump miniport driver is initialized so that the size is able to be viewed in the system log.

14. The information processing device according to claim 9, wherein, before the exception in the operating system, the one or more processors are further configured to perform:
pre-setting, by the operating system, the dump memory block and specifying, by the operating system, a size of a storage resource occupied by the dump memory block as a third memory capacity, wherein the first memory capacity is greater than or equal to the third memory capacity.

15. The information processing device according to claim 9, wherein:
after calling the crash dump driver to read the first memory capacity occupied by the storage resource allocated for the dump memory block, the one or more processors are further configured to perform:
setting, by the crash dump driver, a memory capacity occupied by a storage resource of a dump stack to the first memory capacity; and
after determining the target memory capacity of the dump memory block based on the determination result, the one or more processors are further configured to perform:
initializing and loading a dump port driver and the dump miniport driver through the crash dump driver; and
using the dump stack to call the dump port driver and the dump miniport driver, to copy the data in the physical memory in the operating system to the storage device to obtain a crash dump file.

16. The information processing device according to claim 15, wherein the one or more processors are further configured to perform:
after the operating system is restarted, checking whether there is a crash dump file to be dumped in the storage device; and
when it is determined that there is a crash dump file to be dumped in the storage device, dumping the to-be-dumped crash dump file to an external storage device, so as to read the dumped crash dump file in the external storage device and debug the crash dump file using a predefined debugger.

17. A non-transitory computer-readable storage medium, storing a computer program that, when being executed, causes at least one processor to implement an information processing method comprising:
when an exception occurs in an operating system, calling a crash dump driver to read a first memory capacity occupied by a storage resource allocated for a dump memory block;
based on the first memory capacity, obtaining a determination result as to whether the storage resource of the dump memory block satisfies a storage resource required when a dump miniport driver corresponding to a storage device is initialized; and
based on the determination result, determining a target memory capacity of the dump memory block, wherein a storage resource corresponding to the target memory capacity satisfies the storage resource required when the dump miniport driver is initialized, and the target memory capacity is used to initialize the dump miniport driver so that data in a physical memory in the operating system is able to be copied to the storage device.

18. The non-transitory computer-readable storage medium according to claim 17, wherein the at least one processor is caused to further implement:
obtaining a second memory capacity of the storage resource required when the dump miniport driver is initialized; and
obtaining the determination result based on a size relationship between the first memory capacity and the second memory capacity.

19. The information processing device according to claim 18, wherein the at least one processor is caused to further implement:
when there is a first size relationship between the first memory capacity and the second memory capacity, obtaining a determination result indicating that the storage resource of the dump memory block does not satisfy the storage resource required when the dump miniport driver is initialized; and
when the first size relationship does not exist between the first memory capacity and the second memory capacity, obtaining a determination result indicating that the storage resource of the dump memory block satisfies the storage resource required when the dump miniport driver is initialized.

20. The information processing device according to claim 17, wherein the at least one processor is caused to further implement:
when the determination result indicates that the storage resource of the dump memory block does not satisfy the storage resource required when the dump miniport driver is initialized, increasing the first memory capacity of the dump memory block, wherein the increased first memory capacity is the target memory capacity; and
when the determination result indicates that the storage resource of the dump memory block satisfies the storage resource required when the dump miniport driver is initialized, determining the first memory capacity to be the target memory capacity.
